(19) United States
(12) Patent Application Publication
(10) Pub. No.: US 2006/0064502 A1
(43) Pub. Date: Mar. 23, 2006

(54) Using Popular IDs To Sign On Creating A Single ID for Access

(75) Inventor: Nagendra Nagarajayya, Pleasanton, CA (US)

Correspondence Address: Mr. Nagendra Nagarajayya, 4302 Denker Dr, Pleasanton, CA, 94588, US

(73) Assignee: TRANSAXTIONS LLC, Pleasanton, CA (US)

(21) Appl. No.: 11/162,735

(22) Filed: Sep. 21, 2005

Related U.S. Application Data
(60) Provisional application No. 60/612,272, filed on Sep. 22, 2004.

(51) Int. Cl. G06F 15/16

(52) U.S. Cl. 709/237; 709/246

(57) ABSTRACT

Every being has a presence and can be associated with an ID. Popular IDs such as AOL ID, Yahoo ID, MSN ID, SIP ID, or PSTN and mobile telephone numbers, etc. are used by people to read their emails, send IMs, talk, interact, watch TV, etc. IDs such as biometrics IDs and social security IDs, RFIDs, etc. are used for more secure access. But, these popular IDs cannot be used for other purposes like logging on to ENeedsOnline auction process or making a purchase online or banking online, etc. The present invention describes a way to improve a user's experience of signing in and creating a presence, and associating these popular IDs with a Single ID allowing access to portals, online banking, shopping, etc. It also solves the bigger problem of keeping track of multiple IDs and the passwords associated with the IDs.

### FIELD OF THE INVENTION

The present invention relates to activating a presence using a Single ID. The Single ID uses popular IDs to sign on turning on the presence.

### BACKGROUND OF THE INVENTION

Every Individual has a presence. To identify this presence we have IDs such as National ID, Social Security Number, Yahoo user ID, AOL user ID, MSN user ID, Google mail ID, SIP ID, PSTN or Mobile telephone number, driver's license, biometric information, etc. These forms of identification are used to authenticate a presence to say “who the presence is supposed to be”, and not another presence.

Before the internet authenticating an individual's presence was easy, as one could use a driver's license, a social security number, a telephone number, a home address, etc. With the advancement of the internet, online banking, portals, shopping, etc. have become popular. Most of these websites having proprietary login mechanisms, and need a login id/password for authentication. An individual might have bank accounts, accounts at portals like Yahoo, AOL, MSN/Hotmail, Google mail, like2fone.com, etc. If the individual shops online, most stores need accounts to be created at their store. So now the individual has IDs for bank accounts, IDs for portals, IDs for emails, IDs for shopping online, IDs for chatting, mobile phone ID, SIP ID, etc. These are a lot of IDs, numbers, and passwords that one has to remember to sign on to these sites.

The liberty specification aims to allow consumers and businesses to maintain personal information securely, provide a standard for single sign-on with decentralized authentication and open authorization from multiple providers, and provide an open standard for network identity spanning all network devices. Single Sign on is the ability to sign on once and access enterprise and intranet sites without logging in again. Federated identity allows a user to login at one service provider's site and move to an affiliated service provider site without having to re-authenticate or re-establish their identity.

The passport specification similar to liberty specification allows consumers and business to register and provides a Single Sign on and Federated login capability.

The above two specifications are easing the problem with multiple identities as they allow Single Sign on capability to access sites within their circle of trusts and partner networks.

A definite need stills exists for a Single ID that can activate a presence using popular IDs such as a Yahoo ID, AOL ID, MSN/Hotmail ID, Google ID, SIP ID, National ID, Mobile number, etc. that would overcome the problems associated and described above. A presence can be a Yahoo presence that provides access to Yahoo functionality or an AOL presence that provides AOL related functionality or MSN/Hotmail presence that provides MSN functionality or a SIP presence that allows SIP functionality or a Mobile number that allows mobile phones functionality, etc. In addition to these functionalities and capabilities, a passport or liberty enabled presence will allow access across the liberty circle of trust or the passport network. A primary purpose of the present invention is to solve these needs and provide further, related advantages.

### BRIEF DESCRIPTION OF THE INVENTION

The purpose and idea of the invention is to use popular IDs like AOL or Yahoo or MSN or SIP ID, mobile telephone numbers, or IDs such as RFID tag, National ID, Social Security Number, biometrics, etc. to sign on and activate a presence. Most internet users have a AOL or Yahoo or MSN or Google account. VoIP users have a SIP ID. Mobile phone users have an account at their service provider. These IDs are very popular and used by people to read their emails, send IMs, SMS, talk, watch TV, interact, etc. But these IDs are proprietary and cannot be used for other purposes like logging on to ENeedsOnline auction process or making a purchase online or banking online, etc. The present invention describes a way to improve a user's experience of signing in and creating a presence, and not creating IDs on every internet site but using popular IDs to access these sites. It also solves the bigger problem of keeping track of multiple IDs and passwords, and provides the user a single ID from which other internet sites can be accessed.

### BRIEF DESCRIPTION OF THE DRAWINGS

The accompanying drawings, which are incorporated into and constitute a part of this specification, illustrate one or more embodiments of the present invention and, together with detailed description, serve to explain the principles and implementations of the invention.

FIG. 1 is a screen snapshot illustrating a user trying to sign in into the myhouse-online portal using the popular Yahoo ID.

FIG. 2 is a flow chart illustrating the process followed by the invention to verify that the ID is a valid Yahoo ID.

FIG. 3, is a screen snapshot illustrating the failure of the “Sign In” process.

FIG. 4 is a screen snapshot illustrating the success of the “Sign In” Process, the Welcome page is shown.

FIG. 5 is a screen snapshot illustrating using the myhouse-online IM client to connect to the IM server as well as to show the IM connection to Yahoo through the myhouse-online Yahoo gateway.

FIG. 6 is a screen snapshot illustrating using the myhouse-online Email client showing the Welcome email sent to the user using the Yahoo ID.

FIG. 7 is a screen snapshot illustrating using the myhouse-online “NewUser” option to create an account and register popular IDs.

### REFERENCES CITED

U.S. PATENT DOCUMENTS

| | | | |
|---|---|---|---|
| 6748057 | June 2004 | Ranalli, et al. | 379/88.17 |
| 6941295 | September 2005 | Nakamura, et al. | 707/3 |
| 6941291 | September 2005 | Zoller, et al. | 707/1 |
| 6938160 | August 2005 | Oono | 713/186 |

U.S. PUBLISHED APPLICATIONS

| | | | |
|---|---|---|---|
| 20050198545 | September 2005 | Wieck, Kyoko Takeda; | 713/323 |
| | | et al. | |
| 20050198501 | September 2005 | Andreev, Dmitry; et al. | 713/168 |
| 20040250118 | December 2004 | Andreev, Dmitry; et al. | 713/201 |
| 20050191992 | September 2005 | Inoue, Atsushi; et al. | 455/411 |
| 20050171898 | August 2005 | Bishop, Fred; et al. | 705/67 |
| 20040139081 | July 2005 | Barrett, Michael Richard; | 707/100 |
| | | et al. | |
| 20050180618 | August 2005 | Black, Gerald R. | 382/124 |
| 20050166043 | July 2005 | Zhang, Hong; et al. | 713/155 |

### OTHER REFERENCES

1. Project Liberty, Liberty Specification, Single Sign on, Federated Identity, http://www.projectliberty.org/resources/specifications.php, http://www.projectliberty.org/specs/liberty-idwsf-authn-svc-v1.1pdf, pp. 26-28, http://www.projectliberty.org/specs/draft-liberty-idff-arch-overview-1.2-errata-v1.0.pdf, pp. 6-42

2. Microsoft Passport, https://accountservices.passport.net/ppnetworkhome.srf?vv=310&Ic=1033, Single Sign on and Access Management, http://www.microsoft.com/technet/security/topics/identitymanagement/idmanage/default.

3. Ajoy Kumar, Federated Identity Management, http://www.securitydocs.com/pdf/2782.PDF, December 2004

4. SIP, http://en.wikipedia.org/wiki/Session_Initiation_Protocol

5. SIP and XMPP Presence, http://en.wikipedia.org/wiki/Presence_Information

6. Jabber IM and Presence, http://en.wikiedia.org/wiki/Jabber

7. Gaim, allows multiple IM accounts to be managed from a single client, http://gaim.sourceforge.net/win32/index.php

8. Horde, IMP, Reading pop mail from multiple servers, http://www.horde.org/imp/

9. SIP URI, http://www.softarmor.com/wgdb/docs/draft-mahy-sipping-user-equals-phone-00.html, telephone numbers URI, http://rtc3966.x42.com/

10. ENUM Numbering scheme, http://www.enum.org/information/files/enumpaper.pdf

11. ENUM validation, http://www.e164.org/, http://www.like2fone.com

12. ‘Digital Birth ID’ stirs privacy debate, Aug. 13, 2005

13. David Berlind, National IDs: They're coming, one way or the other, Jan. 09, 2002

14. Smack API, access jabber services through a Java API, http://www.jivesoftware.org/smack/

15. JWChat, A HTML based Jabber Client, http://jwchat.sourceforge.net/

### CROSS-REFERENCE TO RELATED APPLICATIONS

This application claims priority of U.S. provisional application, number U.S. 60/612,272, titled “Using Popular IDs To Sign On Creating A Single ID For Access” filed Aug. 22, 2004 by the present applicant.

### DETAILED DESCRIPTION OF PREFERRED EMBODIMENTS

Embodiments of the present invention are described herein in the context of a method and apparatus for emulating a competitive process. Those of ordinary skill in the art will realize that the following detailed description of the present invention is illustrative only and is not intended to be in any way limiting. Other embodiments of the present invention will readily suggest themselves to such skilled persons having the benefit of the disclosure. Reference will now be made in detail to the implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation—specific decisions must be made in order to achieve the developer's specific goals, such as compliance with application—and business related constraints, and that these specific goals will vary from one implementation to another and from one developer to another. Moreover, it will be appreciated that such a development effort might be complex and time consuming, but would nevertheless be routine undertaking of engineering for those of ordinary skill in the art having the benefit of this disclosure.

In accordance with the present invention, the components, process steps, and/or data structures may be implemented using various types of operating systems, computing platforms, computer programs, and or/general purpose machines. In addition, those of ordinary skill in the art will recognize that devices of a less general purpose nature such as hardwired devices, field programmable gate arrays (FPGAs), application specific integrated circuits (ASICs), or the like, may also be used without departing from the scope and spirit of the inventive concepts disclosed herein.

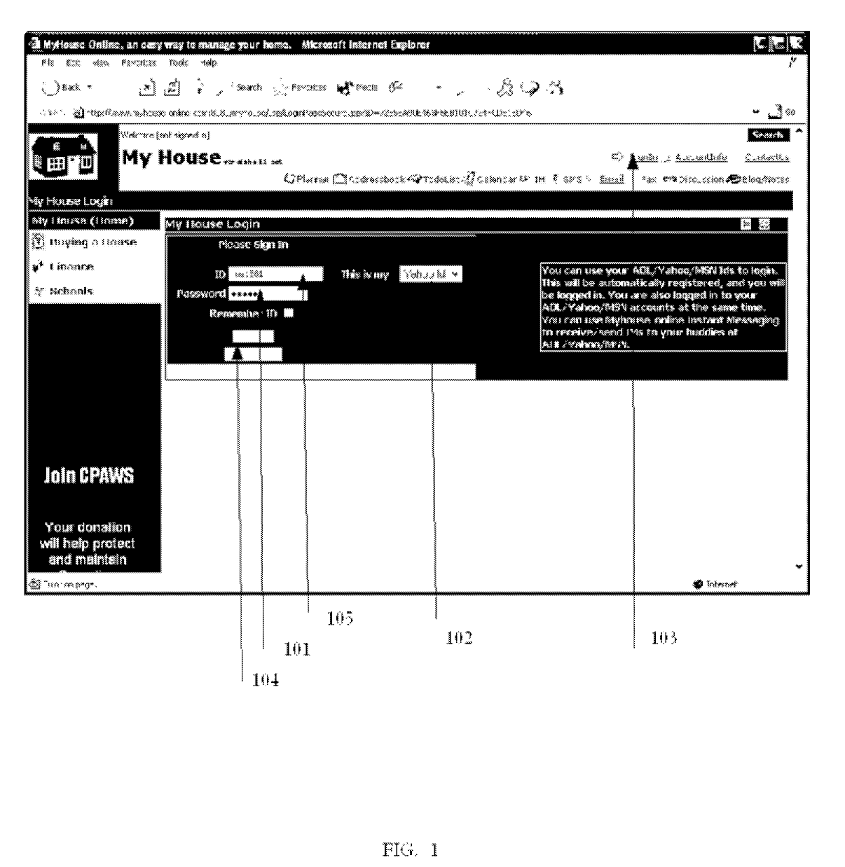

FIG. 1 is a screen snapshot illustrating a user trying to sign in into the myhouse-online portal using the popular Yahoo ID. In this example, 103 is the option used to bring up the Login page. 105 is where the user enters the Yahoo ID, 101 the password, 102 to select the ID type, and 104 to “Sign In” using the Yahoo ID. In this embodiment a Yahoo login is shown but in another embodiment, a AOL login or a MSN login or a SIP login, etc. might be shown.

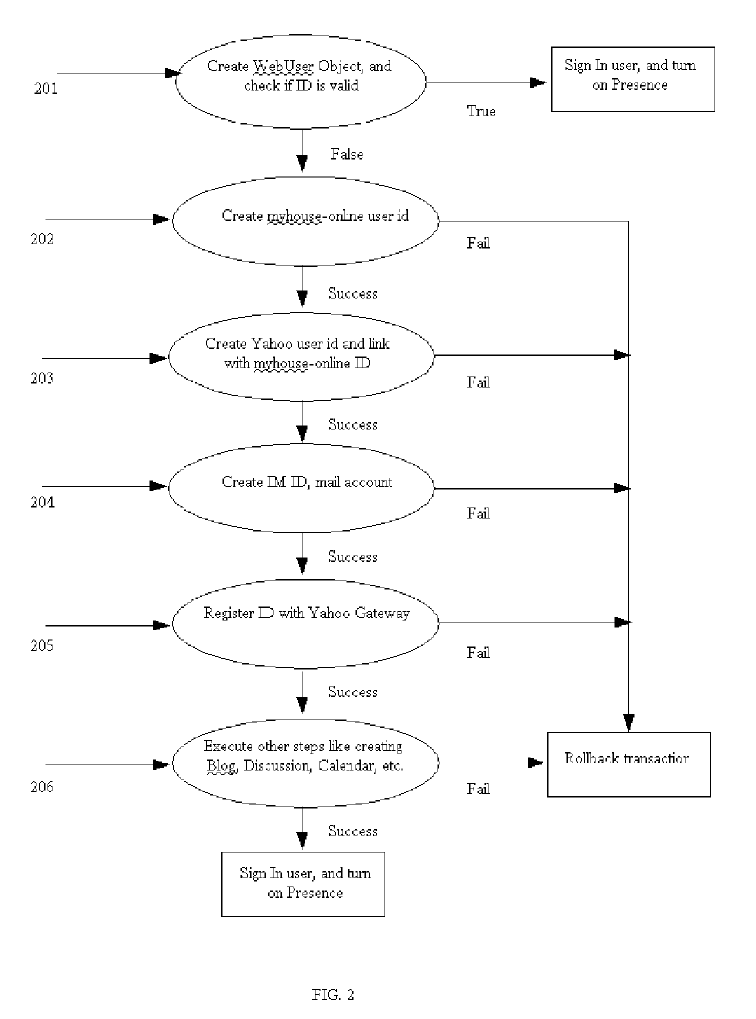

FIG. 2 is a flow chart illustrating the process followed by the invention to verify that the ID is a valid Yahoo ID once 104 is used to “Sign In”. Clicking on “Sign In” button sends the login request to a Tomcat Application Server. In step 201, on receiving the login request, a new WebUserObject is created with the Yahoo ID as the user id, and the Yahoo password as the password after encrypting it. The WebUserObject checks if the user id and login type (Yahoo, AOL, MSN, SIP ID, etc.) exist in the database by sending in a SQL query. If the user id exists then the valid user flag is set to true, to indicate that the user id has already been registered with the database. If the valid flag is true then the user is signed in, the Yahoo presence is made “Available”, and any Yahoo messages like mail, etc. are made available to the user. If the valid flag is false, in step 202 a myhouse-online ID is created in the database by inserting a record in the users table. The user-id field is set to a unique integer value, the user-name field is set to the Yahoo ID, the password field is set to the Yahoo password after encrypting it using the MD5 algorithm, the type field is set to “myhouse-online”, the myhouse_online_userid field is set to −1, to indicate that this is a myhouse-online user id. If the insertion fails, an error message is displayed to the user indicating why the “Sign In” failed, and the transaction is rolled back.

If this is successful, in step 203, another record is inserted into the users table to create the Yahoo ID. The user_id field is set to a unique integer value, the user_name field is set to the Yahoo ID, the password field is set to the Yahoo password after encrypting it using the MD5 algorithm, the type field is set to “yahoo”, the myhouse_online_userid field is set to user_id from step 202 to link the myhouse-online user id with the Yahoo user id. If the insertion fails, an error message is displayed to the user indicating why the “Sign In” failed, and the transaction is rolled back.

If the record is inserted successfully, in step 204, a myhouse-online IM and Mail accounts are created by sending a message to the IM and Mail server. A new serverclient object is created, and the addUser method is invoked with the Yahoo ID, encrypted password and name information. The addUser methods makes a TCP connection to the IM and Mail Server to establish a connection with the serveradmin application running on the server. The serverclient sends a add message followed by the myhouse-online ID, password, Yahoo ID, password and name information. The serveradmin receives the add information message and invokes the vadduser.sh script. The vadduser.sh script creates a IM ID by running adduser.pl script which creates a roster entry for the myhouse-online ID. The vadduser.sh also creates a mail account using the myhouse-online ID. If any of these fail, the serveradmin returns an error message back to the serverclient, which throws an exception, and the transaction is rolled back.

If step 204 is successful, in step 205, the Yahoo ID is registered with myhouse-online Yahoo gateway. A new jabberMyhouseIM object is created with the myhouse-online user ID and password. The jabberMyhouseIM constructor calls the setUp method which uses the smack API to create a XMPPConnection connection object to login into the IM server using the myhouse-online ID and password. The registerYahoo method is invoked with the Yahoo ID and password. The registerYahoo method calls the testjabberRegister method to test if the Yahoo ID is a valid ID. A new Registration object is created and the type is set to GET. The To field is set to the gateway address for Yahoo. The connection object is used to send the registration packet to the IM server. A AndFilter object is created with IQ.class, FromFilter set to the gateway server, and the ToFilter set to the Yahoo ID. A PacketCollector object is created with the AndFilter object, and the PacketCollector nextResult method is invoked to wait for a response from the IM server. The nextResult method returns a Packet as a response. This Packet is converted to a IQ packet, and the getChildElementXML method is invoked to retrieve the XML response message. A new DOMBuilder object is created and the build method is invoked with the XML response message as the parameter to create a JDOM Document object. The rootElement is retrieved and iterated using the child nodes to parse the XML response message. The parsed message results in registration fields that need to be sent back to the gateway. A HashMap object is created to hold the registration fields. The Yahoo ID is set in the username field, the password is set into the password field, and the key in the key field. A new Registration object is created with the type set to IQ.Type.SET. The setAttributes method is invoked with the HashMap object. The Registration packet is sent to the IM server using the connection object.

A new OrFilter for a IQ or a Presence message is created. Next an AndFilter is created with a FromFilter set to the gateway server, and ToFilter set to the Yahoo ID. A new AndFilter is created with the OrFilter and the AndFilter, so that only a IQ or a Presence message from the myhouse-online Yahoo gateway server is received with the Yahoo ID. A new PacketCollector object is created using the connection object. The collector object is used to wait for a response in a loop using the nextResult method. The nextResult method has a parameter value of 100 ms, so that if there is no response in about 100 ms, it returns. A count is decremented to keep track of the attempts. If a packet is received, it is checked to see if it is a IQ type or a Presence type. If it is presence type, it is checked for errors, and if there is an error, an exception is thrown. If there are no errors, and the count is 0, the loop is exited. An exception results in the transaction being rolled back.

No exception indicates a successful registration, and in step 206, the other steps needed to create a new account like creating a calendar account with the Yahoo ID, a Discussion account, a Blog account, etc., are executed. If there are errors, the transaction is rolled back, and if there are no errors, a Welcome page is shown to the user to indicate successful registration of the Yahoo ID.

It should be noted that in the described embodiment, an object oriented programming environment has been described to discuss the present invention. Object Oriented Constructs such as methods, object, and exceptions have been used to describe how the invention works. However, this can also be implemented in other programming environments and languages. It should also be noted that in this embodiment an IM method has been used to establish the identity and activate the presence of the user, but in other embodiments, a SIP ID, a biometric ID, a Mobile number, a RFID, Social Security number or National ID, etc. might be used to validate an identity and activate a presence using other methods of validation.

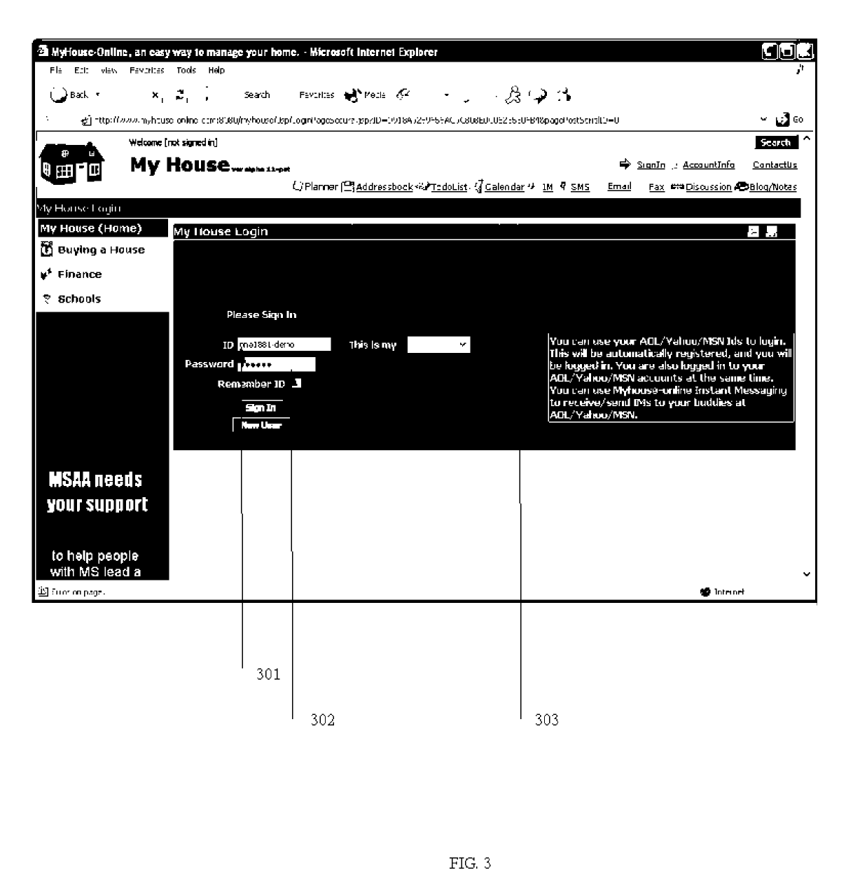

FIG. 3, is screen snapshot illustrating the failure of the “Sign In” process. The Failure could be that the Yahoo ID might not be valid or that a similar ID already exists in the database. In field 301 a Yahoo ID has been entered, 302 is the password field, 303 is the error message indicating the failure. The failure is because the Yahoo ID is not a valid ID.

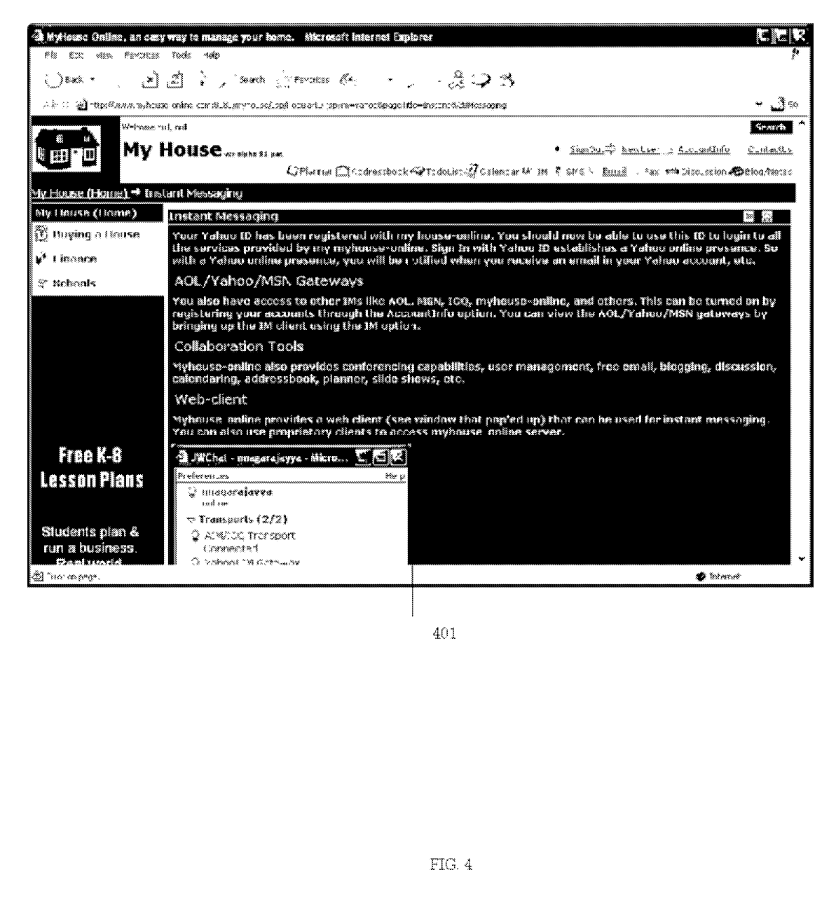

FIG. 4 is a screen snapshot illustrating the success of the “Sign In” Process. 401 is the welcome message shown to the user.

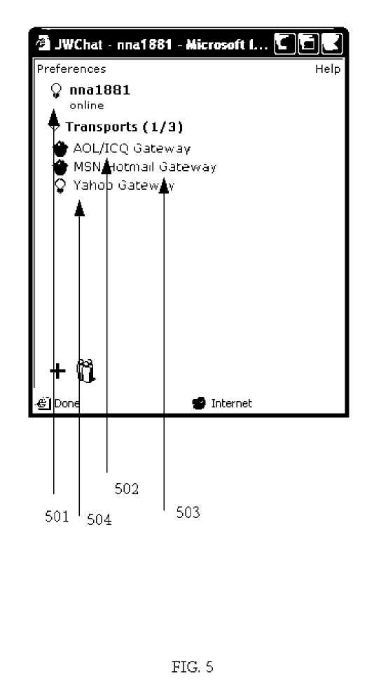

FIG. 5 is a screen snapshot illustrating using the myhouse-online IM client to connect to the IM server as well as to show the IM connection to Yahoo through the myhouse-online Yahoo gateway. Bringing up the IM window could also activate other presences like AOL presence, MSN presence, etc. 501 shows myhouse-online ID, and myhouse-online presence. 504 shows Yahoo presence through the Yahoo gateway. 502 shows the AOL presence through the AOL gateway, and 503 shows the MSN gateway.

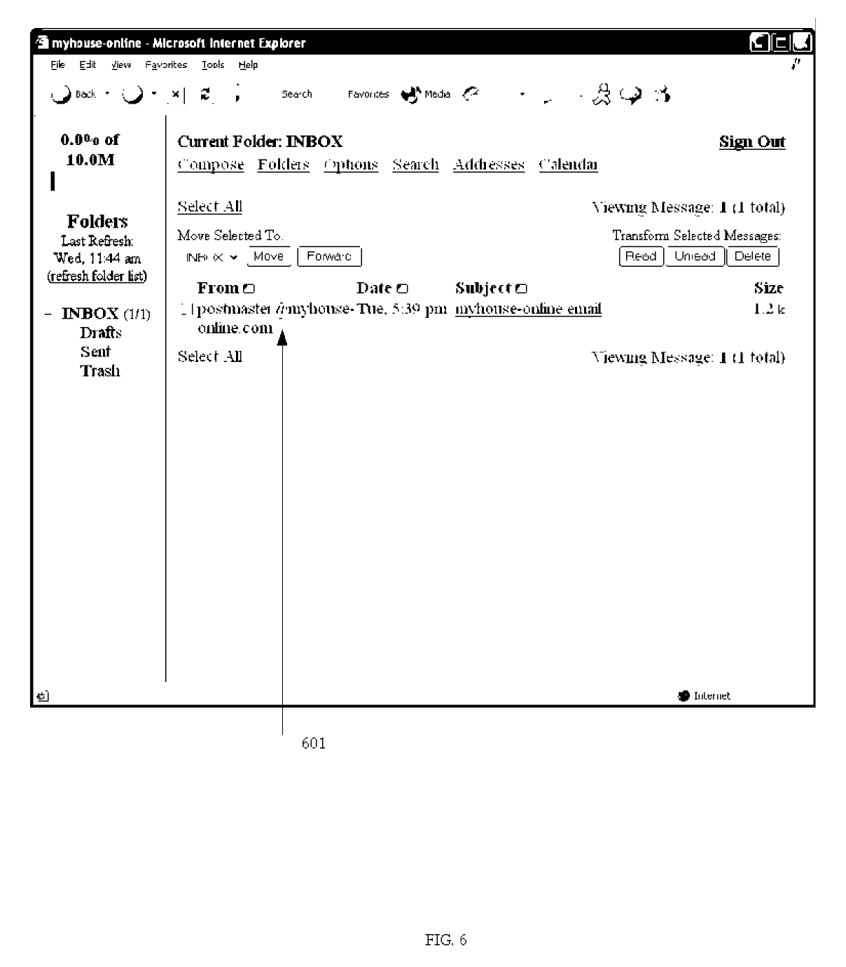

FIG. 6 is a screen snapshot illustrating using the myhouse-online Email client and shows 601 the Welcome email sent to the user using the Yahoo ID.

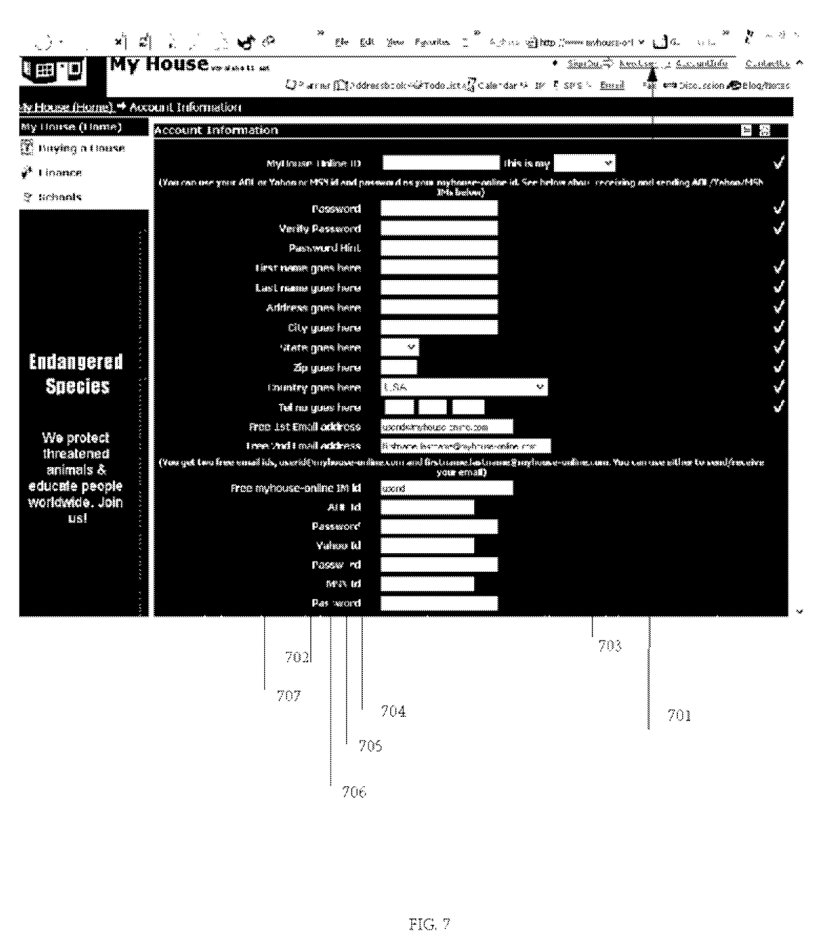

FIG. 7 is a screen snapshot illustrating using the myhouse-online “NewUser” option to create an account and register popular IDs. This option allows multiple IDs to be associated with myhouse-online ID, and any of the IDs can be used to login in. A login with a Yahoo ID provides a Yahoo presence and provides access to Yahoo functionalities like IM, Email, etc. A login with myhouse-online ID turns on myhouse-online presence along with the associated ID presences. The presences can be turned on/off as needed. So a single ID, myhouse-online ID can turn on multiple presences at the same time. A presence such as liberty or passport will allow access to every site allowing access to liberty or passport enabled clients. A SIP presence will allow access to VoIP, etc. 701 is the “New User” option to create a new myhouse-online user account. Clicking on this link brings up the “Account Information” Page. In field 702, a user can enter the new myhouse-online ID. If a user already has a AOL/Yahoo/MSN account, and wants to use it as the myhouse-online ID, it can be entered in 702 and the type selected using 703. If you have accounts at AOL/Yahoo/MSN or others, then these could be registered using fields 704, 705, 706. 707 is a read only field of 702 to indicate that the myhouse-online ID will also be used as the IM ID. The new user account can be created by clicking on the submit button. A similar process as in FIG. 2 is used to verify that the popular IDs are valid and can be registered with the gateways. In this embodiment a few popular IDs are shown. But in another embodiment, registration of more popular IDs like a SIP ID, Biometric ID, PSTN or Mobile Telephone number, Social Security number, etc. could be shown.

While embodiments and applications of this invention have been shown and described, it would be apparent to those skilled in the art having benefit of this disclosure that many more modifications than mentioned above are possible without departing from the inventive concepts herein. The invention, therefore, is not to be restricted except in the spirit of the appended claims.

Definition List 1

| Term | Definition |
|---|---|
| Myhouse-online | A portal that can be accessed at |
| | http://www.myhouse-online.com |
| Yahoo | Yahoo is a popular portal that can be accessed at |
| | http://www.yahoo.com |
| AOL | AOL is a popular portal that can be accessed at |
| | http://www.aol.com |
| MSN/Hotmail | MSN is a popular portal that can be accessed at |
| | http://www.msn.com |
| Google | Google is a very popular search engine, offering |
| | email and other services at http://www.google.com |
| ENeedsOnline | ENeedsOnline, an online marketplace where buyers |
| | and sellers can make available a need at |
| | http://www.eneedsonline.com |
| Browser | A Graphical User Interface for viewing content |
| | called html on the web |
| Web | World wide web, www, also known as the internet |
| Java | An object oriented programming language |
| IP | Internet Protocol |
| TCP | Transmission Control Protocol |
| URL | Uniform Resource Locator |
| VoIP | Voice over Internet Protocol |
| SMS | Short message service |
| IM | Instant messaging |
| GET | A HTTP method to send/get data from a server |
| POST | A HTTP method to send/get data from a server |
| HTTP | A TCP/IP based text request/response protocol that |
| | allows web browsers to show data from a server |
| | called a web server |
| Session | A J2EE HTTP session object, and provides a way to |
| | identify a user across more than one page request |
| | or visit to a Web site and to store information about |
| | that user. |
| J2EE | Java 2 Platform, Enterprise Edition defines the |
| | standard for developing component-based |
| | multitier enterprise applications |
| Jsp | JavaServer Pages technology provides a simplified, |
| | fast way to create dynamic web content |
| JDOM | JDOM is a Java API to manipulate XML, |
| | http://jdom.org |
| SIP | Session Initiation Protocol, |
| | http://www.cs.columbia.edu/sip/ |
| Gateway | Jabber Gateway, SIP/SIMPLE gateway, etc. Gateways |
| | provide a way to access another protocol or source. |
| | So an email at Yahoo could be read through a |
| | gateway, |
| | http://www.jabber.org/software/components.shtml |
| SQL | Structured Query Language, A language to access |
| | data in a Relational Database System (RDBMS) |

What is claimed is:

1. A method to activate a presence using a popular ID in a computer based system, the method comprising:
Associating a popular ID with a Single ID, validating the said popular ID, registering the said popular ID, and activating a presence associated with the said popular ID;
Associating a plurality of popular IDs with a Single ID, validating the said popular IDs, registering the said popular IDs, and activating a plurality of popular ID presences.

2. A method according to claim 1 wherein said popular ID can be used to activate a presence; said activated presence allows access to popular ID functionalities.

3. A method according to claim 1 wherein said Single ID associated with the popular ID can be used to activate the popular ID presence; said popular ID presence allows access to popular ID functionalities.

4. A method according to claim 1 wherein said Single ID associated with a plurality of popular IDs can be used to activate a plurality of popular ID presences; said activated presences allow access to functionalities associated with the said popular IDs.

5. A method according to claim 1 wherein said Single ID can exist independent of popular ID with its own presence; said Single ID presence provides access to Single ID functionalities; said Single ID associated with a popular ID allows presence and functionality to be shared; said Single ID associated with a plurality of popular IDs allows presence and functionalities to be shared.

6. A program storage device readable by a machine, tangibly embodying a program of instructions readable by a machine to perform a method for activating a presence using a popular ID in a computer based system, the method comprising:
Associating a popular ID with a Single ID, validating the said popular ID, registering the said popular ID, and activating a presence associated with the said popular ID;
Associating a plurality of popular IDs with a Single ID, validating the said popular IDs, registering the said popular IDs, and activating a plurality of popular ID presences.

7. The program storage device according to claim 6 wherein said popular ID can be used to activate a presence; said activated presence allows access to popular ID functionalities.

8. The program storage device according to claim 6 wherein said Single ID associated with the popular ID can be used to activate the popular ID presence; said popular ID presence allows access to popular ID functionalities.

9. The program storage device according to claim 6 wherein said Single ID associated with a plurality of popular IDs can be used to activate a plurality of popular ID presences; said activated presences allow access to functionalities associated with the popular IDs.

10. The program storage device according to claim 6 wherein said Single ID can exist independent of a popular ID with its own presence; said Single ID presence provides access to Single ID functionalities; said Single ID associated with a popular ID allows presence and functionality to be shared; said Single ID associated with a plurality of popular IDs allows presence and functionalities to be shared.

11. An apparatus for activating a presence using a popular ID, the apparatus comprising:
A popular ID;
a presence;
a Single ID;
a plurality of Popular IDs;
a plurality of presences;
said popular ID is associated with a Single ID; said popular ID is validated and activates a presence associated with the said popular ID; said popular ID is registered if not registered;
said plurality of popular IDs is associated with a Single ID; said popular IDs are validated and registered if not registered, activating a plurality of presences associated with the said popular IDs.

12. The apparatus according to claim 11 wherein said popular ID can be used to activate a presence; said presence allows access to popular ID functionalities.

13. The apparatus according to claim 11 wherein said Single ID associated with the popular ID can be used to activate the popular ID presence; said activated presence allows access to popular ID functionalities.

14. The apparatus according to claim 11 wherein said Single ID associated with a plurality of popular IDs can be used to activate a plurality of popular ID presences; said activated presences allow access to popular ID functionalities.

15. The apparatus according to claim 11 wherein said Single ID can exist independent of the popular ID with its own presence; said Single ID presence provides access to Single ID functionalities; said Single ID associated with a popular ID allows presence and functionality to be shared; said Single ID associated with a plurality of popular IDs allows presence and functionalities to be shared.
